(19) United States
(12) Patent Application Publication
(10) Pub. No.: US 2012/0249300 A1
(43) Pub. Date: Oct. 4, 2012

(54) DETERMINATION OF LOCATION USING RSSI AND TRANSMIT POWER

(76) Inventors: Shlomo Avital, Jerusalem (IL); Miri Ratner, Ramat Gan (IL)

(21) Appl. No.: 13/075,381

(22) Filed: Mar. 30, 2011

(51) Int. Cl. G08B 5/22

(52) U.S. Cl. 340/8.1

(57) ABSTRACT

In various embodiments, the location of a wireless communications device may be found by determining the distance to at least one other communications device whose location is known. Each distance may be determined by examining the transmit power and received signal strength indicator for a transmission from that device. Triangulation techniques may be used to convert multiple distances from multiple devices into a location.

### BACKGROUND

Determining the location of electronic devices, either in absolute terms (on the earth's surface) or in relative terms (relative to other devices) has become increasingly useful and popular. Various methods of determining such locations have been developed. For example, GPS satellite signals allow location to be determined absolutely within a few feet outdoors, but this technique is unreliable indoors due to shielding of the satellite signals by the building. Indoor location with respect to other nearby devices may be accomplished in several ways. In one, the distance to other devices whose locations are known may be determined and triangulation used to calculate position. But determining distance is difficult. Traditional methods measure the received signal strength of the incoming signals, assuming they were all transmitted with the same transmit power, and measuring the relative dissipation of each signal by the time it's received (i.e., the weaker the signal, the farther it is assumed to have traveled). But modern networks may adjust transmit power separately for each device to conserve power and avoid interference. This may render the received signal strength technique unreliable.

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a number of wireless devices that can communicate with each other, according to an embodiment of the invention.

FIG. 2 shows a process for obtaining a location of a mobile device, according to an embodiment of the invention.

FIG. 3 shows a flow diagram of a method of obtaining a location of a wireless device, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a non-transitory computer-readable medium, which may be read and executed by one or more processors to enable performance of the operations described herein. Such a computer-readable medium may include any tangible non-transitory mechanism for storing information in a form readable by one or more computers, such as but not limited to read only memory (ROM); random access memory (RAM); magnetic disk storage media; optical storage media; a flash memory device, etc.

The term “wireless” may be used to describe circuits, devices, systems, methods, techniques, communications channels, etc., that communicate data by using modulated electromagnetic radiation through a non-solid medium. The term does not imply that the associated devices do not contain any wires. A wireless device may comprise at least one antenna, at least one radio, at least one memory, and at least one processor, where the radio transmits signals through the antenna that represent data and receives signals through the antenna that represent data, while the processor may process the data to be transmitted and the data that has been received. The processor may also process other data which is neither transmitted nor received.

As used within this document, the term “network controller” is intended to cover devices that schedule and control, at least partially, wireless communications by other devices in the network. A network controller may also be known as a base station (BS), access point (AP), central point (CP), or any other term that may arise to describe the functionality of a network controller.

As used within this document, the term “mobile device” is intended to cover those devices whose wireless communications are at least partially scheduled and controlled by the network controller. A mobile device (MD) may also be known as a mobile station (MS), STA, subscriber station (SS), user equipment (UE), or any other term that may arise to describe the functionality of a mobile device. Mobile devices may move during such communications, but movement is not required.

In various embodiments, the relative location of a device may be determined by estimating the distance of that device from each of multiple other devices whose positions are known, and possibly using triangulation techniques to determine the location. Each distance may be determined by using the received signal strength at the receiver and the transmit power at the transmitter. Since wireless signal strength decreases at a relatively predictable amount with distance traveled, these two factors can produce the distance. The number of other such devices used in this manner to determine location may vary, depending on the desired accuracy.

In some embodiments the resultant location may be stored in the device whose location was determined, but in other embodiments the location for this and multiple other devices maybe stored in a location client device, where it may be provided upon request.

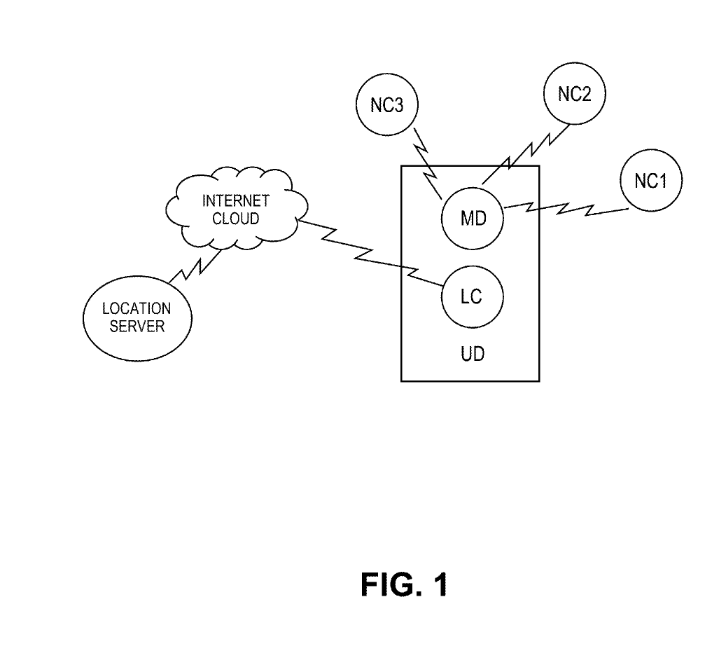

FIG. 1 shows a number of wireless devices that can communicate with each other, according to an embodiment of the invention. The illustrated embodiment shows a single user device (UD) that is within wireless communications distance of three network controllers (NC1, NC2, NC3) and also has an internet connection. The radio(s) that communicate with the NCs and the UD connection with the internet may use the same or different hardware/software/interfaces, but are shown as different functional interfaces for this discussion. The UD may be any type of portable device capable of wireless communication, such as a smart phone. The UD may contain a portion MD that meets the earlier definition of a mobile device, for communicating wirelessly with the NCs. The UD may also contain a location client LC that obtains the location of the UD through the techniques described in this document. In the illustrated example, the LC may communicate location information with the Location Server through the internet. In particular, the LC may obtain the location of the UD through the techniques described in this document, and then communicate that location to the location server so that the location of the UD may be made available to other devices. Although the LC is shown as a part of the UD, and may in fact be implemented entirely in the software of the UD, in some embodiments it may be in a separate device and communicate with the MD either wirelessly or through a cable.

It is presumed that in this example the location of the MD (and hence the UD) is to be determined, the locations of NC1, NC2, and NC3 are already known, and the location of the MD will be stored in the LC once it is determined. But other embodiments may have a network with a different configuration of devices. Although the location of a mobile device is shown being determined from multiple network controllers whose locations are already known, in other embodiments the location of a single device may be determined from multiple non-network controllers whose locations are known, regardless of what function those devices perform. Further, the location may be stored in another device than the one shown. In some embodiments, once the location of the MD is stored, it may be provided to other devices upon request. For those devices whose location is already known before this process starts (e.g., NC1, NC2, NC3), the method of determining their location is beyond the scope of this document.

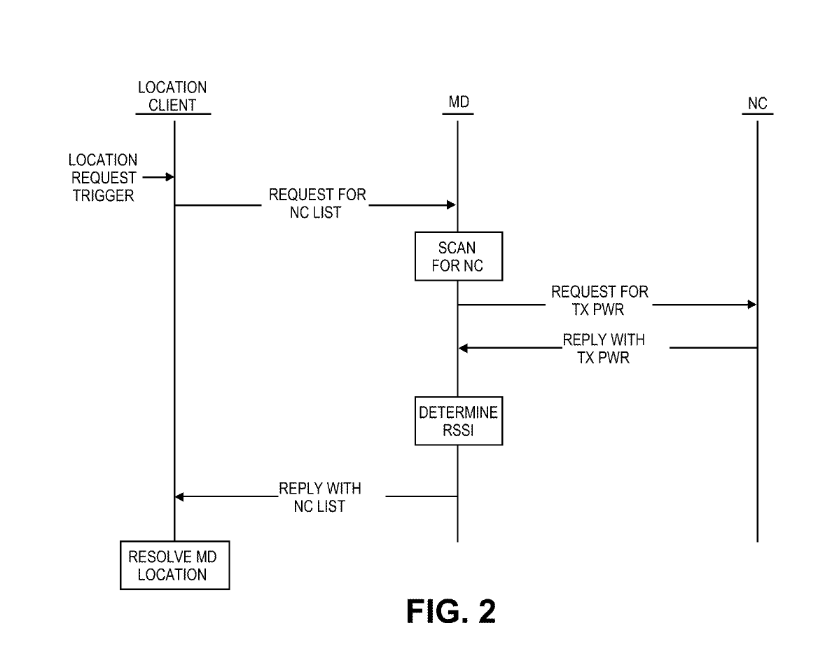

FIG. 2 shows a process for obtaining a location of a mobile device, according to an embodiment of the invention. The illustrated process begins when an LC receives a request for the location of the mobile device labeled MD in FIG. 2. Alternately, the LC may initiate this process on its own, without being triggered by an external request.

Once the location request has been initiated, the LC may send a request to the indicated MD for certain information. In particular, it may request that the MD provide values for transmit power (TxPwr) and received signal strength indicator (RSSI) for a transmission from the indicated NC to the indicated MD. This, and any other relevant information, is indicated as a ‘list’ since it contains multiple values, but any other term for the requested information may be used. This information may be used later to determine the requested location of the MD. If the MD is not registered with the NC, it may scan for the NC and register once the NC is found. If it is already registered with the NC, the registration step may be skipped.

The MD may then get the NC to transmit data to the MD, the data containing a value for the TxPwr used in the transmission. In some embodiments, the MD may specifically request a TxPwr value in a message. In other embodiments, this information may be provided by the NC without request, such as sending it in a beacon, or sending it in various types of transmissions.

When the MD receives the transmission from the NC, the MD can measure the strength of the received signal, and thus determine a value for RSSI. Both of these values (TxPwr and RSSI) can then be transmitted back to the LC, along with any other pertinent information (such as the ID of the relevant NC). In some embodiments, the NC may also provide its own location in its transmission to the MD, and the MD may pass that information on to the LC. In other embodiments, the LC may already know the location of the NC, and delivering that information may not be necessary.

Once the LC has obtained the TxPwr and RSSI values from the MD, the LC may determine the distance from the MD to the NC. In some embodiments, this may be calculated based on the dissipation rate of RF signals through air. In other embodiments it may be obtained from a lookup table. Still other techniques may be used.

Regardless of the technique used, determining the distance from the MD to a single NC is usually not enough to calculate the location of the MD, even if the location of the NC is known. This information, by itself, is only enough to determine the MD is located somewhere along the edge of a circle with the NC at its center. More information may be needed to locate the MD to a single point.

In some embodiments the LC may repeat the above process with the same MD but different NCs. Two NCs may provide enough information to locate the MD to one of two points, where the respective circles intersect. A third NC may reduce the choices down to one of those two points. More than three NCs may statistically reduce the tolerances that are inherent in the process.

In other embodiments, the direction of the incoming signal received by the MD from the NC may be combined with the distance from the MD to the NC to determine the MD's location. Various techniques for determining this direction are known, and are not repeated here.

The sequence shown in FIG. 2 depicts an LC that is a separate device from the MD and the NC, but other embodiments might locate the LC functionality within one of the MD's or NC's in a network. Similarly, the sequence shown in FIG. 2 depicts the calculations involving TxPwr and RSSI taking place in the LC, but other embodiments may make those calculations in the MD.

The previous examples described the location of each NC as being known, either to the NC itself or to the LC. If the location of each NC is known in absolute terms (i.e., a point on the surface of the earth), the location of the MD may also be determined in absolute terms. If the location of each NC is only known in relative terms (e.g., with respect to each other or to other nearby objects), then the location of the MD may be determined in such relative terms.

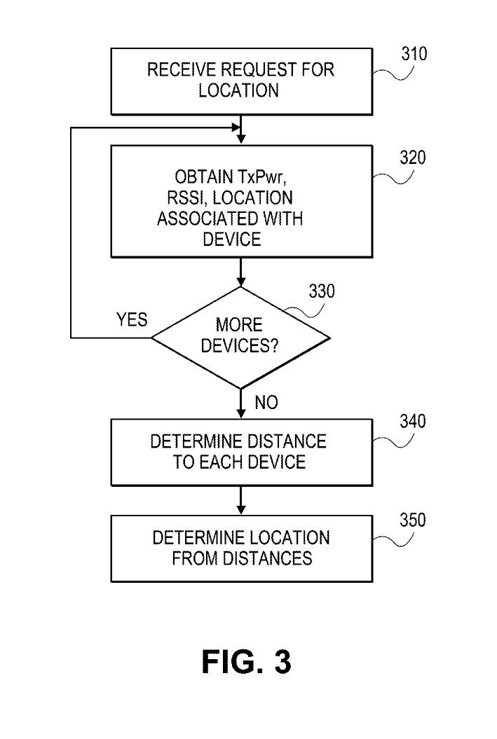

FIG. 3 shows a flow diagram of a method of obtaining a location of a wireless device, according to an embodiment of the invention. In some embodiments, this method may be performed in the LC of FIG. 2, in other embodiments it may be performed in the MD of FIG. 2. At 310, a request may be received for the location of a particular device. This may be an external request from another device that wants to know the location of MD, or it may be an internal trigger that attempts to get this information proactively before it is requested by another device.

At 320, a request may be sent out for at least two items of information associated with a particular remote device other than the device for which the location is being requested. These items are the transmit power level, and the associated received signal strength indicator, for a transmission from the particular remote device to the device for which the location is being requested. If the operation of 320 is being performed by the LC, the identity of both the MD and the NC may be included in the request. In other embodiments the MD may be allowed to designate an NC on its own. If the operation of 320 is being performed by the MD, the request may be directed at the NC that was requested by the LC, or the MD may be allowed designate an NC on its own. When the MD designates an NC on its own, it may designate one that is already known to it, or it may seek and find an NC within range. In some embodiments the location of each NC may be included in the transmission from that NC, but in other embodiments that information may already be known.

At 330 this process may be performed for multiple remote devices, and the relevant information obtained for transmissions from each one to the device for which a location is sought. Using the transmit power level and received signal strength indicator for a transmission from each NC to the MD, the distance from each NC to the MD may be determined at 340. Using the location information for each of multiple NCs, and the distance from the MD to each of those multiple NCs, triangulation techniques may be used to determine the location of the MD at 350.

Assuming that the MD is able to move around, its location may need to be updated from time to time to keep the location information relatively accurate. Thus the request for location may need to be repeated periodically. This request may be made at regular intervals, or may be triggered by events that indicate the probability of movement.

The foregoing description is intended to be illustrative and not limiting. Variations will occur to those of skill in the art. Those variations are intended to be included in the various embodiments of the invention, which are limited only by the scope of the following claims.

What is claimed is:

1. A method, comprising:
obtaining a first set of values for transmit power, received signal strength indicator (RSSI), and device location for a first transmission from a first transmitting device to a receiving device, wherein the transmit power value indicates transmit power for the transmission at the transmitting device, the RSSI indicates RSSI for the transmission at the receiving device, and device location indicates location of the transmitting device; and
determining a location of the receiving device at least partly from the first set of values.

2. The method of claim 1, wherein:
said obtaining comprises obtaining a second set of values for transmit power, RSSI, and device location for a second transmission from a second transmitting device to the receiving device; and
said determining comprises determining the location of the receiving device at least partly from the first and second set of values.

3. The method of claim 1, wherein said determining is performed in the receiving device.

4. The method of claim 1, wherein said determining is performed in a device other than the receiving device.

5. The method of claim 1, wherein a value for the first transmitting device location is contained in the associated transmission.

6. The method of claim 1, wherein a value for the first transmitting device location is previously known by the device doing the determining of the location of the receiving device.

7. The method of claim 1, wherein said determining the location of the receiving device is performed using a triangulation technique.

8. The method of claim 1, further comprising communicating a request for a location of the receiving device, prior to said obtaining the first set of values.

9. A wireless communications apparatus having a processor, a memory, and a radio, the apparatus adapted to:
obtain a first set of values for transmit power, received signal strength indicator (RSSI), and device location for a first transmission from a first transmitting device to a receiving device, wherein the transmit power value indicates transmit power for the transmission at the transmitting device, the RSSI indicates RSSI for the transmission at the receiving device, and device location indicates location of the transmitting device; and
determine a location of the receiving device at least partly from the first set of values.

10. The apparatus of claim 9, wherein the apparatus is further adapted to:
obtain a second set of values for transmit power, RSSI, and device location for a second transmission from a second transmitting device to the receiving device; and
determine the location of the receiving device at least partly from the first and second set of values.

11. The apparatus of claim 9, wherein said determining is to be performed in the receiving device.

12. The apparatus of claim 9, wherein said determining is to be performed in a device other than the receiving device.

13. The apparatus of claim 9, wherein a value for the first transmitting device location is to be contained in the associated transmission.

14. The apparatus of claim 9, wherein a value for the first transmitting device location is to be previously known by the device doing the determining of the location of the receiving device.

15. The apparatus of claim 9, wherein said determining the location of the receiving device is to be performed using a triangulation technique.

16. The apparatus of claim 9, wherein the apparatus is further to communicate a request for a location of the receiving device, prior to said obtaining the first set of values.

17. A computer-readable non-transitory storage medium that contains instructions, which when executed by one or more processors result in performing operations comprising:
obtaining a first set of values for transmit power, received signal strength indicator (RSSI), and device location for a first transmission from a first transmitting device to a receiving device, wherein the transmit power value indicates transmit power for the transmission at the transmitting device, the RSSI indicates RSSI for the transmission at the receiving device, and device location indicates location of the transmitting device; and
determining a location of the receiving device at least partly from the first set of values.

18. The medium of claim 17, wherein:
the operation of obtaining comprises obtaining a second set of values for transmit power, RSSI, and device location for a second transmission from a second transmitting device to the receiving device; and
the operation of determining comprises determining the location of the receiving device at least partly from the first and second set of values.

19. The medium of claim 17, wherein the operation of determining is performed in the receiving device.

20. The medium of claim 17, wherein the operation of determining is performed in a device other than the receiving device.

21. The medium of claim 17, wherein a value for the first transmitting device location is contained in the associated transmission.

22. The medium of claim 17, wherein a value for the first transmitting device location is previously known by the device doing the determining of the location of the receiving device.

23. The medium of claim 17 wherein the operation of determining the location of the receiving device is performed using a triangulation technique.

24. The medium of claim 17, wherein the operations further comprise communicating a request for a location of the receiving device, prior to said obtaining the first set of values.
